(19) United States
(12) Patent Application Publication
(10) Pub. No.: US 2023/0115083 A1
(43) Pub. Date: Apr. 13, 2023

(54) METHODS OF USING BIDIRECTIONAL CHARGING TO SUPPLY BACK-UP POWER AND INCREASE RESILIENCY OF POWERED NETWORKS

(71) Applicant: FERMATA ENERGY LLC, Wilmington, DE (US)

(72) Inventors: David SLUTZKY, Albemarle County, VA (US); John WHEELER, Charlottesville, VA (US); Scott BRIERLEY, Thompsons Station, TN (US)

(21) Appl. No.: 17/500,449

(22) Filed: Oct. 13, 2021

(51) Int. Cl. B60L 55/00; B60L 53/63; B60L 53/30

(52) U.S. Cl. CPC B60L 55/00; B60L 53/63; B60L 53/305; B60L 2240/72

(57) ABSTRACT

The present invention describes systems and methods for providing a resilient bidirectional charging infrastructure, including a plurality of smart poles connected in a circuit and a processor configured to cause the at least one of the plurality of smart poles to receive electricity from an electric vehicle based on an actual or predicted loss of electricity within the circuit. The plurality of smart poles is configured to provide at least part of a powered network, such as a 5G network, and at least one of the plurality of smart poles has an interface for receiving electricity from an electric vehicle.

### BACKGROUND

The present disclosure generally relates to deploying electric vehicle batteries as back-up power to supply power to powered network components through a bidirectional charging infrastructure.

With impacts of climate change resulting in more severe weather events occurring more frequently, there has been an increase in widespread power outages. This may particularly have a large impact on 5G, or fifth generation wireless technology, which is currently being deployed and is gaining popularity. Compared to prior networks, 5G will offer higher speeds, lower latency, and increased bandwidth availability. 5G will also lead to a greater capacity of mobile networks. 5G will lead to more flexible wireless connectivity and integrate different functions. 5G will require more numerous cell sites than 4G or other previous wireless networks, but these cell sites will be smaller. This is often referred to as “densification.”

Many applications, including Internet of Things (IoT), autonomous vehicles emergency services, telemedicine, and other extensions, will likely leverage 5G networks. These types of users of 5G networks will require higher reliability than traditional cellular systems as life and death outcomes may result from loss of 5G access even for short periods of time. Companies such as AT&T, T-Mobile, and Verizon have launched 5G networks and begun developing and deploying “smart cells” or “smart poles” or antennas or installations, that can be used with 5G, in addition to other existing networks (e.g., 4G or LTE), future generations of networking technology (e.g., 6G), or other forms of applied bandwidth technologies.

### BRIEF SUMMARY

The present disclosure is directed to systems, apparatus, methods, and computer program products for providing continuous access to back-up power for “smart cells,” “smart poles,” antennas, or installations of powered networks, including but not limited to 5G, through a resilient bidirectional charging infrastructure.

### BRIEF DESCRIPTION OF THE DRAWINGS

FIG. 1A is an example of a smart pole for providing or receiving back-up power via bidirectional charging according to an embodiment of the present invention.

FIG. 1B is an example of a resilient smart pole system for providing back-up power via bidirectional charging according to an embodiment of the present invention.

FIG. 2 is an example of a resilient infrastructure for providing back-up power via bidirectional charging according to an embodiment of the present invention.

FIG. 3 is an example of a resilient infrastructure for providing back-up power via bidirectional charging according to an embodiment of the present invention.

FIG. 4 is an example of a resilient infrastructure for providing back-up power via bidirectional charging according to an embodiment of the present invention.

FIG. 5 is a flow diagram for using a resilient smart pole system to provide back-up power via bidirectional charging according to an embodiment of the present invention.

In the aforementioned figures, like reference numerals refer to like parts, components, structures, and/or processes.

### DETAILED DESCRIPTION OF THE INVENTION

As will be understood by those of ordinary skill in the art, aspects of the present disclosure may be illustrated and described herein in any of a number of patentable classes or contexts, including any new and useful process, machine, manufacture, or composition of matter, or any new and useful improvement thereof. Accordingly, aspects of the present disclosure may be implemented entirely as hardware, entirely as software (including firmware, resident software, micro-code, etc.), or by combining software and hardware implementations that may all generally be referred to herein as a “circuit,” “module,” “component,” or “system.” Furthermore, aspects of the present disclosure may take the form of a computer program product embodied in one or more computer-readable media having computer-readable program code embodied thereon.

Any combination of one or more computer-readable media may be utilized. The computer-readable media may be a computer-readable signal medium or a computer-readable storage medium. A computer-readable storage medium may be, for example, but not limited to, an electronic, digital, magnetic, optical, electromagnetic, or semiconductor system, apparatus, or device, or any suitable combination of the foregoing. More specific examples (a non-exhaustive list) of the computer-readable storage medium would include the following: a portable computer diskette, a hard disk, a random-access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable signal medium may be transmitted using any appropriate medium, including but not limited to wireless, wireline, optical fiber cable, radio frequency (RF), etc. or any suitable combination thereof.

Computer program code for carrying out operations for aspects of the present disclosure may be written in any combination of one or more programming languages, such as any of the programming languages listed at https://githut.info/(e.g., JAVASCRIPT, JAVA, PYTHON, CSS, PHP, RUBY, C++, C, SHELL, C#, OBJECTIVE C, etc.) or other programming languages. The program code may be executed by a processor or programmed into a programmable logic device. The program code may be executed as a stand-alone software package. The program code may be executed entirely on an embedded computing device or partly on an embedded computing device (e.g., partly on a server and partly on a personal computer and partly on an embedded device). The program code may be executed on a client, on a server, partly on a client and partly on a server, or entirely on a server or other remote computing device. The program code also may be executed on a plurality of a combination of any of the foregoing, including a cluster of personal computers or servers. The server or remote computing device may be connected to the client (e.g., a user's computer) through any type of network, including a local area network (LAN), a wide area network (WAN), or a cellular network. The connection also may be made to an external computer or server (e.g., through the Internet using an Internet Service Provider) in a cloud computing environment or offered as a service such as a Software as a Service (SaaS).

Powered networks provide access to the networks through base stations or other network access components. In the example of 5G deployments of “smart cells” or “smart poles” or antenna or installations provide access to the 5G network and are increasingly including additional features beyond enabling users to connect to the network, thus making the deployments multifunctional. Some examples of other technologies that may be part of a “smart cell,” “smart pole,” antenna, or installation, include Wi-Fi access, cameras (e.g., traffic camera or surveillance camera) or other sensors/detectors, lights, charging plugs for electric vehicles, electronic billboards or other form of advertisement, and solar power or other green energy. Deploying “smart cells” or “smart poles” or antennas or installations as multifunctional units may lead to increased power requirements to support the various functionalities incorporated into the deployments.

These increased power needs are coupled with increasing use of powered networks for applications that require consistent connectivity to the powered network. Applications such as autonomous vehicles, may need increased resilience, in that constant (or near constant) access to the network is required for the application to function safely and/or effectively. Another example requiring increased resilience is in a disaster situation (e.g., natural disaster like a hurricane or other disaster like a gas plant explosion). During a long power outage, it may be important to get the communication grid up and running in order to enable coordinating responses for rescue efforts and managing efforts to begin fixing other problems. A source of back-up power may be required in the event of a loss of power to the “smart cells,” “smart poles,” antennas, or installations of the powered network.

One option would be to have large back-up batteries located at each of the “smart cells,” “smart poles,” antennas, or installations. However, this would be cumbersome and expensive. In addition, this type of back-up battery would remain stationary at the “smart cells,” “smart poles,” antennas, or installations, and would be unused most of the time, causing them to degrade over time. Eventually, such a stationary back-up battery would run out of charge. This would then require a person to travel to the location of the “smart cell,” “smart pole,” antennas, or installations with a new battery, disconnect the old battery, replace it with the new battery, and reconnect the new battery to the “smart cell,” “smart pole,” antennas, or installation. Further, the cost effectiveness of large, stationary back-up batteries or other stationary storage systems and devices may impede scale deployment of new network technologies, such as 5G, and create increased risk for use cases depending on total or near total reliability. Ultimately, this solution would be inefficient and impractical, particularly considering the size of the battery being considered. Another potential solution would be to use a diesel generator during a long, widespread outage. However, it is common for diesel fuel to become scarce during natural disasters with prolonged outages. In these circumstances, alternative energies, such as solar power and wind generation may still be online, but unable to reach the sites that need power because the distribution grid is down.

A need exists for a way to ensure reliable, continuous power supply to “smart cells,” “smart poles,” antennas, or installations in order to support applications where resiliency to availability of the network is key.

The present disclosure is directed to creating a resilient bidirectional charging infrastructure solution to enable access to a rotating, ongoing source of back-up power, for example from electric vehicles, to supply power to “smart cells” or “smart poles” or antenna or installations of a powered network, such as 5G. This may reduce the need to have substantial back-up power located at the site(s) (e.g., a large battery) and decrease the amount of time during which “smart cells,” “smart poles,” antenna, or installations, are without power following a power loss/failure, and thus without access to the powered network, such as 5G. Further, back-up power located at the site(s) would be finite, whereas the disclosed invention could be used to provide a continuous, rotating source of back-up power. The power loss/failure may be widespread due to a grid-wide power outage or may be localized at one or more smart poles due the failure of and/or damage to a particular component (i.e., equipment failure). For consistency, the term “smart pole” will be used throughout this disclosure, but should be interpreted to encompass smart poles, smart cells, antenna, installations, or other structure that is implementing the radio access network (RAN) functionality for a powered network or is otherwise serving as a communication base station or providing cellular access connectivity for a powered network, including but not limited to 5G.

One source of the back-up power of the disclosed embodiments may be electric vehicles capable of bidirectional charging. As concerns for the environment and depletion of resources increase, the use of plug-in electric vehicles has become more popular. Such vehicles include battery electric vehicles (BEVs), plug-in hybrid electric vehicles (PHEVs), and hydrogen fuel cell electric vehicles (FCEVs). These vehicles typically include one or more electric motors that are powered by one or more batteries. For the purposes of the disclosed embodiments, these may be any vehicle with a battery that may be utilized as an energy storage asset, including an electric truck, electric bus, electric car, electric forklift, electric motorcycle, electric scooter, electric wheelchair, electric bicycle, etc.

There are different types of electric vehicle batteries, such as lead-acid, nickel metal hydride, sodium, and lithium-ion. Each such battery may be provided in different storage capacities, which are generally measured in kilowatt-hours (“kWh”). While such batteries are typically found in the foregoing types of exemplary vehicles, they also may be found in other mobile energy storage assets.

Through bidirectional charging capability, the batteries in these mobile energy storage assets, when connected to the smart poles, may discharge power directly into the smart poles. Examples of such bidirectional charging capability, and a charger configured to perform bidirectional charging, are disclosed, for example, in U.S. patent application Ser. No. 16/802,808, published as U.S. Pat. No. 11,135,936, and U.S. patent application Ser. No. 17/102,284, published as U.S. Patent Application Publication No. 2021/0155104 A1, the disclosures of which are hereby incorporated by reference as if fully set forth herein.

The bidirectional charging infrastructure system of the embodiments disclosed here may engage electric vehicle batteries in bidirectional charging. The system may include an operations management component (located on either the electric vehicle or the bidirectional charger) that is configured to analyze factors relating to the electric vehicle and its battery, such as state of charge, anticipated near-term energy requirements for the vehicle, and any other relevant factors, to then determine the optimal use for the battery at that time. The operations management component may then communicate dispatch and/or discharge instructions to one or more electric vehicles and/or one or more bidirectional chargers.

Any suitable number of electric vehicles and bidirectional chargers may be used as part of the disclosed bidirectional charging infrastructure. Aggregation of vehicles and chargers may provide opportunities to maximize ability to respond to power losses and minimize the amount of time (if any) a smart pole is without power. To this end, the disclosed bidirectional charging infrastructure will include a plurality of interconnected smart poles, one or more of which will be configured to perform bidirectional charging with electric vehicles or other mobile energy storage assets.

Aspects of the present disclosure are described herein with reference to flowchart illustrations and/or block diagrams of methods, apparatuses (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. Those computer program instructions may be provided to a processor of a general-purpose computer, special purpose computer, or other programmable data processing apparatus to produce a machine, such that the instructions, which are executed via the processor of the computer or other programmable instruction execution apparatus, create a mechanism for implementing the functions/acts specified in the flowchart and/or block diagram block or blocks.

Those computer program instructions may also be stored in a computer-readable medium that, when executed, can direct a computer, other programmable data processing apparatus, or other devices to function in a particular manner, such that the instructions, when stored in the computer-readable medium, produce an article of manufacture that includes instructions which, when executed, cause a computer to implement the function/act specified in the flowchart and/or block diagram block or blocks. The computer program instructions also may be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

For a more complete understanding of the nature and advantages of embodiments of the present invention, reference should be made to the ensuing detailed description and accompanying drawings. Other aspects, objects and advantages of the invention will be apparent from the drawings and detailed description that follows. However, the scope of the invention will be fully apparent from the recitations of the claims.

The disclosed embodiments involve the interaction of (1) a smart pole compatible with a bidirectional charger; (2) a bidirectional charger, such as the bidirectional electric vehicle charger disclosed in U.S. patent application Ser. No. 17/102,284, published as U.S. Patent Application Publication No. 2021/0155104 A1, the disclosure of which is hereby incorporated by reference as if fully set forth herein; and (3) a mobile energy storage asset, such as an electrical vehicle (also configured for bidirectional charging) to form a resilient smart pole system or infrastructure. In addition, there may be a software system that enables interoperability between the electric vehicle, bidirectional charger, smart pole, and/or any other energy assets (e.g., solar, wind, stationary battery, etc.).

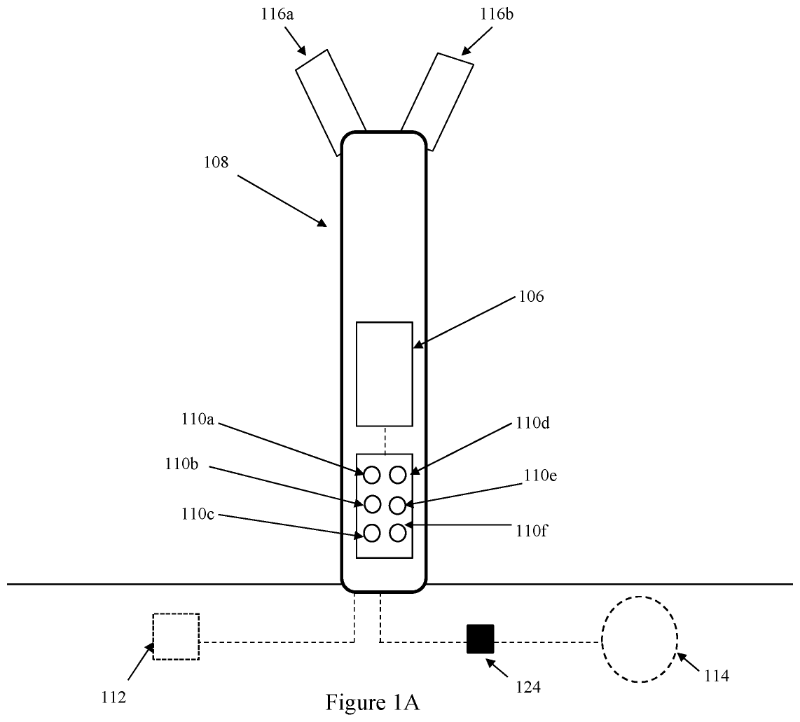

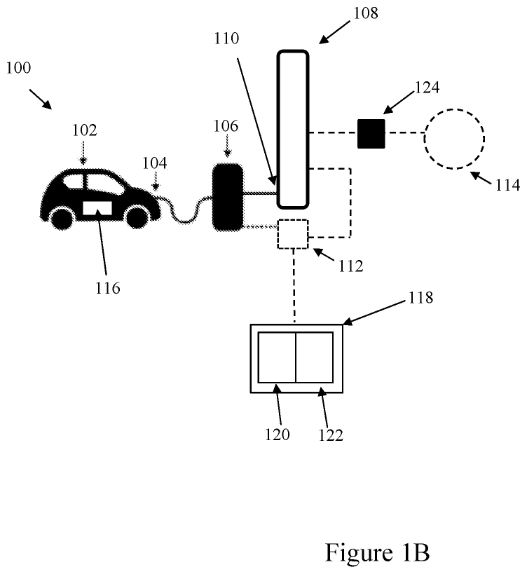

An example of a smart pole 108 is depicted in FIG. 1A. The smart pole 108 may have ports 110a-110f that may allow for connections of other components or applications to the smart pole 108. These ports 110a-f may be any suitable connector depending on the application or component to be used with the smart pole 108. This may be determined by the manufacturer of the smart pole 108 or operator of the deployment of which smart pole 108 is a part (e.g., telecommunications provider or municipality). The ports 110a-f may be capable of receiving a software card or chip to provide functionality to the smart pole 108. The ports 110a-f may also be capable of connecting to a device, such as a bidirectional charger 106, as described in more detail below, through any suitable connector that is compatible with both the smart pole 108 and device that is being connected.

In the example of a bidirectional charger 106, several vehicle communications standards exist. The bidirectional charger port 110a on the smart pole 108 may be required to have an electrical connection or power flow and a communications path for a protocol for accessing the electric vehicle (i.e., a vehicle communications standard). The port 110a may use any suitable vehicle communications standard, such as CHAdeMO, Combined Charging System (CSS), or a proprietary standard (e.g., Tesla). The bidirectional charger 106 may interface or connect to port 110a through any suitable connection mechanism including, but not limited to, a physical cable or inductive charging. This functionality is preferably included in the smart pole 108 in order for the smart pole 108 to be able to receive power discharged from an electric vehicle 102 via a bidirectional charger 106. An electric vehicle 102 must use a communications standard that is compatible with the port 110a on the smart pole 108 in order to engage in bidirectional charging at a particular smart pole 108. The bidirectional charger 106 may be integrated into the smart pole 108, located at the smart pole 108, or integrated with the electric vehicle 102. In the image depicted in FIG. 1A, the bidirectional charger 106 is integrated into the smart pole 108, while the bidirectional charger 106 depicted in FIG. 1B is located at, or near, the smart pole 108.

The smart pole 108 may also be connected to another communications network 112, such as Ethernet, Internet, or any other suitable communications network. This connection to the communications network 112 may be wireless or wired, including via a fiber-optic cable or other cable. The smart pole 108 is connected to a power source 114, such as the electrical grid or any other suitable power source, such as a bank of solar panels. In an example embodiment where the smart pole 108 may be connected to the electrical grid, the system may be grid-tied and/or have a disconnect or islanding feature 124 where the smart pole 108 becomes temporarily isolated from the grid until the grid power is restored. In one example the bidirectional charger 106 may be integrated with a “grid-tie inverter” such that is capable of injecting power into the electric grid or into the smart pole 108 while the smart pole 108 remains connected to and using power from the grid. Common roof-top solar installations use this type of “grid-tie inverter” to partially power a home or building without disconnecting certain loads or the home from the grid. In another example, a disconnect 124 may exist between the smart pole 108 and power source 114 (e.g., to disconnect the smart pole 108 from the power source 114 during an outage of power source 114 to allow electric vehicle 102 to charge smart pole 108).

The smart pole 108 may have one or more antennas, such as antennas 116a, 116b, in order to carry the network signal for users to access and use to communicate via the 5G network. FIG. 1A depicts two antennas (116a, 116b), but smart pole 108 may include any suitable number of antennas. The antennas 116a, 116b may have any suitable shape and be located in any suitable location on the smart pole 108 in order to provide, improve, and/or maximize network access. The two antennas 116a, 116b may be configured to use different communications protocols and/or access different communications networks 112. This may allow for signals or messages to be sent in the event of a loss of access to the 5G network. For example, antenna 116a may communicate via a 5G network and antenna 116b may communicate via Bluetooth.

In addition, the smart pole 108 may include additional functionality as desired by the manufacturer of the smart pole, a telecommunications provider, or other customer using the smart poles (e.g., municipality), depending on the location of the smart pole and the desired functions for the smart pole. For example, the smart pole 108 may also serve as a streetlight and have a light attachment (not pictured) in addition to the components depicted in FIG. 1A. In another example, the smart pole 108 may also serve as a traffic light and may have a stoplight attachment (not pictured) in addition to the components depicted in FIG. 1A. The present invention is designed to be compatible with any smart pole 108 or other component of a 5G network so long as the smart pole 108 has the ability to connect with a bidirectional charger 106 through a port 110a-f or other suitable connection mechanism, such that power may be discharged into the smart pole 108 from a mobile storage asset (e.g., battery of electric vehicle 102) via the bidirectional charger 106.

In the embodiment of a resilient smart pole system 100 depicted in FIG. 1B, an electric vehicle 102 is connected to a bidirectional charger 106 via a quick charge port 104, or other suitable connection mechanism that enables bidirectional charging. The bidirectional charger 106 may then be connected to the smart pole 108 via a bidirectional charger compatible port 110a or other suitable connection mechanism that enables the smart pole 108 to receive power via bidirectional charging. The bidirectional charger 106 may also be in communication with a communications network 112, such as the Internet or local ethernet or another suitable network. The smart pole 108 may also be in communication with the communications network 112. The smart pole 108 also is connected to another power source 114, such as the electrical grid, bank of solar panels, or other suitable power source. This power source 114 may be the primary source of power for the smart pole 108. The smart pole 108 may be any suitable smart pole 108, including those being manufactured by or deployed by AT&T, Verizon, T-Mobile, and Nokia. The communications network 112 may also be in communication with a centralized computer 118 containing a processor 120 and software 122.

The electric vehicle 102 may have an operations management component 116. The electric vehicle 102 may use a distributed software environment where command and control of the electric vehicle 102 may be performed through any suitable interface. This interface may also allow software that is stored in the cloud or on another suitable external server, such as the centralized computer 118, to connect to the electric vehicle 102. The electric vehicle 102 may use the interface to obtain information and issue commands. The electric vehicle 102 may also have the ability to perform remote firmware updates as needed. This may allow for correction of software problems, such as bug fixes, or the ability to add new features and controls to the electric vehicle 102.

In another example (not pictured), the operations management 116 is located on the bidirectional charger 106. The bidirectional charger 106 may use a distributed software environment where command and control of the bidirectional charger 106 may be performed through any suitable interface. This interface may also allow software that is stored in the cloud or on another suitable external server to connect to the bidirectional charger 106. The bidirectional charger 106 may use the interface to obtain information and issue commands. The bidirectional charger 106 may also have the ability to perform remote firmware updates as needed on the device. As previously discussed, this may allow for correction of software problems, such as bug fixes, or the ability to add new features and controls to the bidirectional charger 106.

The instant (or near instant) power to a smart pole, such as smart pole 108, is lost, the disclosed embodiments provide a number of means by which the smart pole 108 may be re-powered through a bidirectional charger 106. Once an operator (e.g., telecommunication provider, 5G network operator, power utility company, etc.) knows power to a smart pole 108 is out, the disclosed system 100 or infrastructure 200 enables the operator to communicate that power loss in such a way as to ensure reliability of service by providing mobile back-up power. In one example embodiment according to the present invention, the back-up power could be supplied from an electric vehicle 102 that is connected to a bidirectional charger 106 plugged in to port 110a of smart pole 108. The electric vehicle may be plugged in at the smart pole 108 at the time of the power loss, or the electric vehicle may be dispatched to the smart pole 108 upon receiving a signal, notification, indicator, message, or otherwise learning that a loss of power occurred at the smart pole 108.

In the example where the electric vehicle 102 already is connected to the smart pole 108 at the time of the power loss, an operator may deploy the already connected electric vehicle 102 to start discharging power into the smart pole to provide power supply to the smart pole until power from the source 114 may be restored. In this example, the smart pole may disconnect from the source 114 (e.g., “islanding”) via the disconnect 124. This can be performed automatically over the communications network 112 by operator software 122 configured to detect and respond to such power loss. This may be performed by centralized computer 118 and/or operations management component 116. This enables providing a nearly instantaneous response to power loss since an electric vehicle 102 is parked, connected, and can discharge back-up power directly into the smart pole 108 as soon as the power loss is detected. The speed of this response is limited only by the speed of the processors 120 and the communications network 112 being used to perform this step. Current processors and networks already operate at speeds that would allow this response to be imperceptible to humans. Thus, this response is referred to throughout this disclosure as being instant (or near instant). In one example, a secondary power source (not pictured) may be located on site of the smart pole 108 to allow the smart pole 108 to remain operational long enough to send and/or receive these signals.

As part of a resilient solution for applications relying on continual access to powered networks, such as autonomous vehicles, the electric vehicle 102 can provide back-up power until the grid goes back up or power is otherwise restored to the smart pole 108. The electric vehicle 102 may remain plugged into the port 110a of the smart pole 108 after the grid goes back up or power is otherwise restored, and the smart pole 108 may then resume charging the electric vehicle 102 at that time.

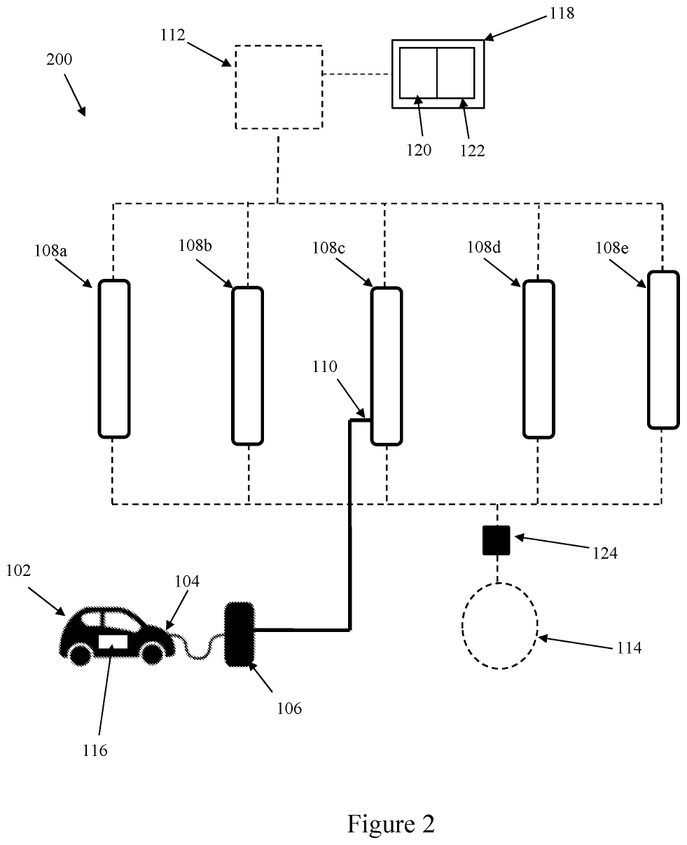

In addition, when there are no power outages or losses to the smart pole 108, the resilient solution may provide charging to electric vehicles, including vehicle-to-grid (“V2G”) charging. Additional discussion of V2G systems, and other applications (i.e., “V2X”) is disclosed in U.S. patent application Ser. No. 16/802,808, published as U.S. Pat. No. 11,135,936, the disclosure of which is hereby incorporated by reference as if fully set forth herein. The resilient system may be used for demand response and vehicle-to-5G (or other network) charging to reduce the peak power of the connected 5G (or other) network infrastructure. This demand charge management is described in U.S. patent application Ser. No. 16/802,808, published as U.S. Pat. No. 11,135,936, the disclosure of which is hereby incorporated by reference as if fully set forth herein. The resilient system could perform these function through a single smart pole 108 (as in FIGS. 1A-B) or multiple smart poles forming a “microgrid” (as in FIGS. 2-4, described in more detail below).

The example embodiment of FIG. 2 depicts a resilient infrastructure 200 that includes five (5) smart poles 108a, 108b, 108c, 108d, and 108e, connected as a circuit to a power source 114, such as the electrical grid, bank of solar panels, or other suitable source of power, and a disconnect 124 may exist between the smart poles 108a, 108b, 108c, 108d, and 108e and power source 114. In this example, an electric vehicle 102 is connected to a bidirectional charger 106 via quick charge port 104 on the electric vehicle 102. The bidirectional charger 106 is connected to smart pole 108c via port 110. In the event there is a power loss at smart pole 108a, which does not have an existing electric vehicle connection, the electric vehicle 102 connected at smart pole 108c, which is on the same circuit as smart pole 108a, may be discharged via the bidirectional charger 106 into the circuit and the power may be routed to supply power to smart pole 108a. Again, this response would be instant (or near instant), as discussed above.

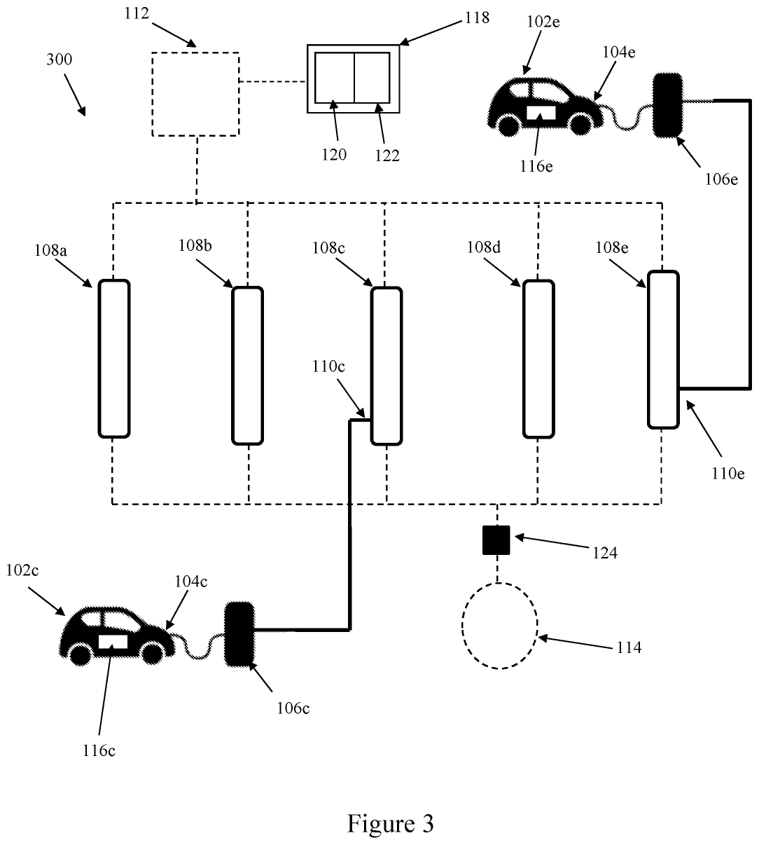

The example embodiment of FIG. 3 depicts a resilient infrastructure 300 that includes five (5) smart poles 108a, 108b, 108c, 108d, and 108e, connected as a circuit to a power source 114, such as the electrical grid, bank of solar panels, or other suitable source of power, with two (2) electric vehicles 102c, 102e also connected to the circuit. A disconnect 124 may exist between the smart poles 108a, 108b, 108c, 108d, and 108e and power source 114. In this example, an electric vehicle 102c is connected to bidirectional charger 106c via quick charge port 104c on the electric vehicle 102c and an electric vehicle 102e is connected to bidirectional charger 106e via quick charge port 104e on the electric vehicle 102e. The bidirectional charger 106c is connected to smart pole 108c via port 110c and the bidirectional charger 106e is connected to smart pole 108e via port 110e. In the example of FIG. 3, the electric vehicles 102c, 102e and the smart poles 108a, 108b, 108c, 108d, and 108e may form a “microgrid.” The disconnect 124 may enable the smaller, “microgrid” system of smart poles 108a, 108b, 108c, 108d, 108e to isolate from the power source 114, such as the electrical grid.

Any number of electric vehicles 102 may be connected to any number of nodes. Thus, while the example embodiment of FIG. 2 is depicted as having five (5) smart poles 108a-108e and one (1) electric vehicle 102, and the example embodiment of FIG. 3 is depicted as having five (5) smart poles 108a-e and two (2) electric vehicles 102c & e, any suitable number of smart poles 108 and/or electric vehicles 102 may be used depending on the needs of the particular network area and/or availability and number of electric vehicles 102 able to be used for this purpose. If an electric vehicle 102 is connected to any one node (e.g., smart pole 108c) in the resilient infrastructure 300, it can supply power to any of the nodes (e.g., smart pole 108a, 108b, 108d, or 108e) in the circuit. For example, in the example embodiment of FIG. 3, electric vehicle 102c may be used to power any of smart poles 108a-e. When electric vehicle 102c is no longer able to discharge into the system, electric vehicle 102e may be begin discharging into smart pole 108e to power any of smart poles 108a-e.

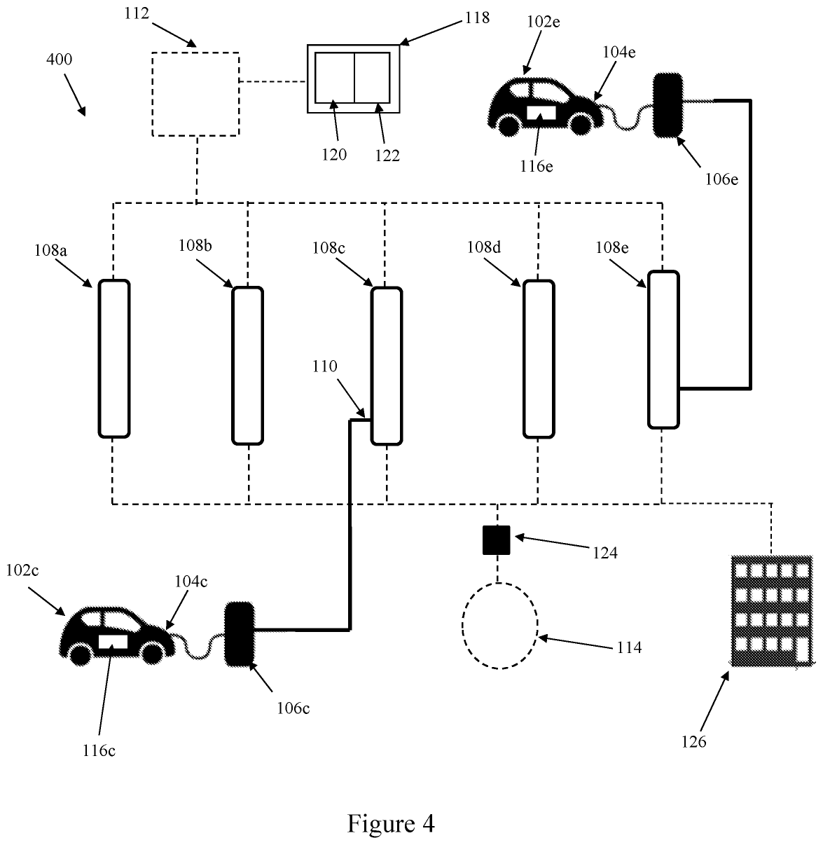

The electric vehicle 102 in FIG. 2 and electric vehicles 102c, 102e in FIG. 3 may also power any component connected to a node of the circuit. The example embodiment of FIG. 4 depicts a resilient infrastructure 400 that includes five (5) smart poles 108a, 108b, 108c, 108d, and 108e, connected as a circuit to a power source 114, such as the electrical grid, bank of solar panels, or other suitable source of power, with two (2) electric vehicles 102c, 102e and a building 126 also connected to the circuit. The building 126 may be residential or commercial. A disconnect 124 may exist between the smart poles 108a, 108b, 108c, 108d, and 108e and power source 114. In this example, an electric vehicle 102c is connected to bidirectional charger 106c via quick charge port 104c on the electric vehicle 102c and an electric vehicle 102e is connected to bidirectional charger 106e via quick charge port 104e on the electric vehicle 102e. The bidirectional charger 106c is connected to smart pole 108c via port 110c and the bidirectional charger 106e is connected to smart pole 108e via port 110e. In the example of FIG. 4, electric vehicle 102c or 102e could provide back-up power to the building 126 via the circuit by discharging into smart pole 108c or 108e, respectively.

The centralized computer 118 may be integrated into or otherwise communicate with the systems of regional transmission organizations (RTO), independent system operators (ISO), utilities (such as power companies), retailer meter customers, 5G service providers (e.g., Verizon, AT&T, or T-Mobile), or even a third party (e.g., Fermata Energy). To effectively optimize the resilient infrastructure 200, 300, 400 disclosed herein, the centralized computer 118 may include a processor 120 and software 122 configured to perform several communication functions, including requesting and receiving state of charge data from an electric vehicle 102, sending charge/discharge instructions to a charger 106 and/or electric vehicle 102, coordinating multiple electric vehicles 102 to offer their capacity as a single resource (aggregation), requesting and receiving an identification of power source being used by the smart pole 108 (e.g., electrical grid, bank of solar panels, or stationary back-up battery), receiving a power loss, power failure, equipment failure, or other loss indicator from the smart pole 108, receiving a power restoration indicator from the smart pole 108, and communicating with operations management component 116 of electric vehicle 102. The electric vehicle(s) 102 and/or the smart poles 108 may include corresponding client-side processors and software configured to perform the corresponding communications functions (e.g., operations management component 116). Although the server-side functionality is described as being performed by a “centralized” computer 118 comprising a processor 120 and software 122, it should be understood that this functionality may be performed by any suitable computing device configured to perform the disclosed server-side functionality, regardless of location (i.e., even if the computing device is not “centralized”).

The processor 120 and software 122 of the centralized computer 118 are configured to determine whether to allow electric vehicles 102 to be deployed for use as vehicles or whether to use them to provide back-up power by discharging the batteries directly into the smart pole 108. In one example, a utility company sends a signal to the centralized computer 118 informing it that there has been a power loss/failure at a smart pole 108 or at a node 108a-108e of a smart pole circuit. In another example, a 5G service provider sends a signal to the centralized computer 118 informing it that there has been an equipment or other loss/failure at a smart pole 108 or at a node 108a-108e of a smart pole circuit. In a third example, monitoring equipment operated at the smart pole 108, such as a sensor in communication with the centralized computer 118, automatically detects a power supply failure or equipment failure and a signal is automatically sent to centralized computer 118 directly from the smart pole 108 itself. And in yet another example, the centralized computer 118 may predict or anticipate a future power, equipment, or other loss, as discussed below. The centralized computer 118 may then determine whether or not to deploy electric vehicles 102 to provide back-up power by discharging the electric vehicle batteries directly into the smart pole 108 or node 108a-108e experiencing actual or predicted power loss, power failure, equipment failure, or other loss. The foregoing communications functions are performed to this end.

The processor 120 and software 122 of the centralized computer 118 also are configured to receive and analyze inputs of various data elements, such as weather data (storm forecast), to effectively optimize the disclosed resilient infrastructure 200. The processor 120 and software 122 of the centralized computer 118 are configured to use such data to predict or anticipate periods where there is a high likelihood of power outages (e.g., due to strong winds, hurricanes, heavy snow, or other weather events), and thus a high likelihood of needing back-up power from mobile energy storage assets (e.g., electric vehicle(s) 102). The centralized computer 118 may then identify available electric vehicles 102 throughout the resilient infrastructure 200 in anticipation of power, equipment, or other loss, which allows the centralized computer 118 to ensure an electric vehicle 102 or suitable number of electric vehicles 102 are available for discharge at smart poles 108 or nodes 108a-e during that time. In this regard, ensuring that electric vehicles 102 are available means ensuring that the electric vehicles 102 are one or more of (i) already plugged in at certain smart poles 108 or nodes 108a-e, (ii) fully charged and ready to be deployed (i.e., capable of safe discharge), and/or (iii) located nearby for quick deployment to affected smart poles 108 or nodes 108a-e to discharge power upon receiving a discharge instruction. In addition, this entails confirming the vehicle(s) 102 use a communications standard compatible with the communications standard of the port 110a-f of the smart pole 108 or node 108a-e.

For predicted or anticipated periods of power, equipment, or other loss, the processor 120 and software 122 of the centralized computer 118 may determine the number of electric vehicles 102 needed to discharge enough electricity to provide sufficient back-up power in the event of an outage. The processor 120 and software 122 of the centralized computer 118 may then ensure that the determined number of electric vehicles 102 will be available during the time of the predicted or anticipated power loss. To perform this action, the processor 120 and software 122 of the centralized computer 118 may learn from previous periods of power outages and predict how many electric vehicles 102 need to be deployed, such as based on the event (e.g., heavy winds and/or snow) and its severity (e.g., 45 mph winds and/or 6 inches of snow). In this way, the centralized computer 118 becomes “smarter” and more accurate over time. This could be achieved, for example, using known artificial intelligence self-learning techniques.

If electric vehicle(s) 102 is (are) already plugged in at or connected to a smart pole 108 or node 108a-e at or just prior to a time of predicted or anticipated power loss, a mechanism, such as an automated lock, may be engaged to prevent the vehicle 102 from being disconnected from the bidirectional charger 106, and thus, the smart pole 108 or node 108a-e. This also may occur when or just after power loss occurs, including if it is determined that more electric vehicles 102 are needed than were predicted or anticipated. This might occur, for example, if a weather event is more severe than predicted or anticipated. In addition, vehicle owners, operators, or managers may be provided with incentives to keep their vehicle 102 “locked in” at the smart pole 108 or node 108a-e during the predicted weather event and allow their vehicle 102 to be discharged into the smart pole 108 or node 108a-e in the event of a loss of power. The incentives may include, but are not limited to, free charging during the duration of the predicted weather event, a credit or reduction on utility bill, or a credit or reduction on bill from telecommunications provider.

In another example, the operations management component 116 of the electric vehicle 102 may prevent the vehicle from being unplugged or disconnected from the smart pole 108 or other node 108a-e in the resilient infrastructure 200, assigned to another location, or otherwise being checked out for use. A message may also be sent to a fleet manager indicating particular electric vehicles 102, or combination of electric vehicles 102, that should not be checked out for use and/or should not be moved from the smart poles 108 or other nodes 108a-e. This may be accomplished through any other suitable method or mechanism, such as automated software communicating via the communications network 112.

The centralized computer 118 may send a discharge instruction to any suitable source of mobile back-up power that is capable of engaging in bidirectional charging such that it is able to discharge into a smart pole 108. The instruction may be sent via the communications network 112. The processor 120 and software 122 may automatically make the determinations described herein regarding deploying and discharging electric vehicles 102 or other sources of mobile back-up power for this purpose, including determining which and how many sources to deploy and discharge. The centralized computer 118 also may automatically prevent the vehicle from being unplugged or disconnected from the smart pole 108 or other node 108a-e in the resilient infrastructure 200, assigned to another location, or otherwise being checked out for use.

Alternatively, the centralized computer 118 may send a message to a manager of a fleet of electric vehicles 102, where the electric vehicles 102 are available for bidirectional charging, informing the manager of a predicted or expected power, equipment, or other loss and identifying which electric vehicles 102 should be made available for discharge and when. Such a message also may be sent to an operator of a V2X system equipped for bidirectional charging, where the V2X system may include vehicle-to-grid applications, vehicle-to-building applications, vehicle-to-home applications, vehicle-to-vehicle applications, etc. (i.e., vehicle-to-X applications, or “V2X”). Additional discussion of V2X systems is disclosed in U.S. patent application Ser. No. 16/802,808, published as U.S. Pat. No. 11,135,936, the disclosure of which is hereby incorporated by reference as if fully set forth herein. This type of message may also be sent to individual electric vehicle owners who sign up, opt in, or otherwise indicate they are willing to use their electric vehicle for V2X applications, including providing back-up power to smart poles in the event of power losses.

If no electric vehicles 102 are connected and a smart pole 108 or node 108a-e experiences a power, equipment, or other loss, a dispatch signal may be sent from the centralized computer 118 indicating the loss of power, power failure, equipment failure, or other loss and requesting deployment of electric vehicles 102 to a particular smart pole 108 or other node 108a-e of the resilient infrastructure 200. In one example, a telecommunications provider may monitor (via centralized computer 118) one or more smart poles 108 or nodes 108a-e to determine if power supply to the smart pole 108 or node 108a-e goes from on to off or if it switches from a primary power source (e.g., electrical grid) to a secondary power source located on site (e.g., solar panels) (not pictured). Based on that determination, the centralized computer 118 may send a signal requesting an electric vehicle 102 or suitable number of electric vehicles 102 be deployed to the site of the smart pole 108 or nodes 108a-e to provide back-up power.

The signal can be sent to an operator or manager of a fleet of electric vehicles, where the electric vehicles are available for bidirectional charging, or to any other suitable source of back-up power via bidirectional charging. The operator or manager may then make deployment and discharge decisions as described above. In another example, the operations management component 116 or other software on the electric vehicle 102 may receive the power loss signal from the smart pole 108 or node 108a-e. The operations management component 116 or other software on the vehicle 102 may automatically determine whether to deploy electric vehicles 102 or not to provide back-up power by discharging the electric vehicle battery directly into the smart pole 108 or node 108a-e upon receiving the signal. As described above, in the example where the recipient is the operations management component 116 or other software 122 running on centralized computer 118 with processor 120, these determinations may occur instantly (or near instantly), as described above, such that any loss of power would not be detectable by a user of the 5G network.

An operator or manager of a fleet of electric vehicles 102, where the vehicles 102 are available for bidirectional charging, may receive messages, as described above, requesting electric vehicles 102 to use as back-up power. In response to receiving the signal, the operator or manager may determine whether to deploy electric vehicles 102 or not to provide back-up power by discharging the electric vehicle batteries directly into the smart pole 108. If the operator or manager determines to deploy electric vehicles 102 to provide back-up power, the operator or manager may evaluate their fleet or inventory of electric vehicles 102 to evaluate the number of vehicles 102 to send and which combination of vehicles 102 to send. In making this determination, the operator or manger may consider the number of vehicles 102 in the fleet or inventory, the number of available vehicles 102, the state of charge of each vehicle 102, the location of the vehicles 102 relative to the location requesting back-up power, and/or any other relevant factor. In another example, instead of the operator or manager, the determination is made automatically by the operations management component 116 of the electric vehicle 102 or by the processor 120 and software 122 of the centralized computer 118, including by analyzing factors such as those described above.

Due to the power supply failure or loss of power, the smart pole 108 may not be able to send signals or communicate via the 5G network, so the signal may be sent via 4G networks, Ethernet, Bluetooth, or another suitable network. The available networks for communication may depend on the functionality at each particular smart pole 108. Some form of stationary back-up power, such as solar power or a small back-up battery, also may be located on the smart pole 108 in order to allow a dispatch signal to be sent (and for mobile back-up power to arrive before the stationary back-up power is depleted). Loss of power may also be determined by the smart pole 108 switching from its main power source 114 to a secondary or back-up power source on site (not pictured). These dispatch signals may be sent from a centralized location that manages the bidirectional charging infrastructure (e.g., the centralized computer 118), from the power (or other utility) company, from a telecommunications provider (or mobile operator) operating the network, company operating the smart pole 108, from the smart pole 108 itself, or from any other suitable component of the resilient infrastructure 200. The secondary or back-up power may allow the smart pole 108 to remain operational long enough to send and/or receive these signals.

Once vehicles 102 are deployed and discharging directly into a smart pole 108, an operator or manager of a fleet of electric vehicles 102, centralized computer 118 with processor 120 and software 122, or the operations management component 116 (or other software on the electric vehicle 102), may monitor the state of charge of the electric vehicle(s) 102 that are connected to smart pole(s) 108 as they are discharging from the battery into the smart pole(s) 108. The operator or manager, centralized computer 188, or the operations management component 116 (or other software on the electric vehicle 102) may determine to stop discharging an electric vehicle 102 during the back-up power operation. In one example, the operator or manager, centralized computer 118, or the operations management component 116 (or other software on the electric vehicle 102) may monitor a state of charge of an electric vehicle 102 that is discharging into a smart pole 108 in order to provide back-up power. In order to ensure continuous back-up power to the smart pole 108, when the percent of charge remaining reaches a certain threshold the operator or manager, centralized computer 118, or the operations management component 116 (or other software on the electric vehicle 102) may arrange for a replacement electric vehicle 102 to be dispatched to the site. For example, the operator or manager, centralized computer 118, or the operations management component 116 (or other software on the electric vehicle 102) may receive a notification when the state of charge remaining drops below 30%. A threshold of 30% charge remaining is merely an example and the operator, manager, centralized computer 118, or the operations management component 116 (or other software on the electric vehicle 102) may define a suitable threshold. Defining the threshold may account for the number of available vehicles using a compatible communications standard, time for replacement vehicle(s) to reach the site, amount of time remaining for currently discharging vehicle 102 to continue discharging, etc. The operator or manager, centralized computer 118, or the operations management component 116 (or other software on the electric vehicle 102) may then send a signal to dispatch a replacement electric vehicle 102 to ensure sufficient power supply to continue supplying power to the smart pole 108.

In another example, the operator or manager, centralized computer 118, or the operations management component 116 (or other software on the electric vehicle 102) may determine to stop discharging an electric vehicle 102 in order to protect the vehicle battery health. The operator or manager, centralized computer 118, or the operations management component 116 (or other software on the electric vehicle 102) may receive a notification that battery health may be negatively affected if it continues to discharge into the smart pole 108. In response to receiving such a notification, the operator or manager, centralized computer 118, or the operations management component 116 (or other software on the electric vehicle 102) may arrange for a replacement electric vehicle 102 to be dispatched to continue supplying back-up power to the smart pole 108. Examples of when battery health may be affected by charging operations are described in U.S. patent application Ser. No. 16/802,808, published as U.S. Pat. No. 11,135,936, the disclosure of which is hereby incorporated by reference as if fully set forth herein.

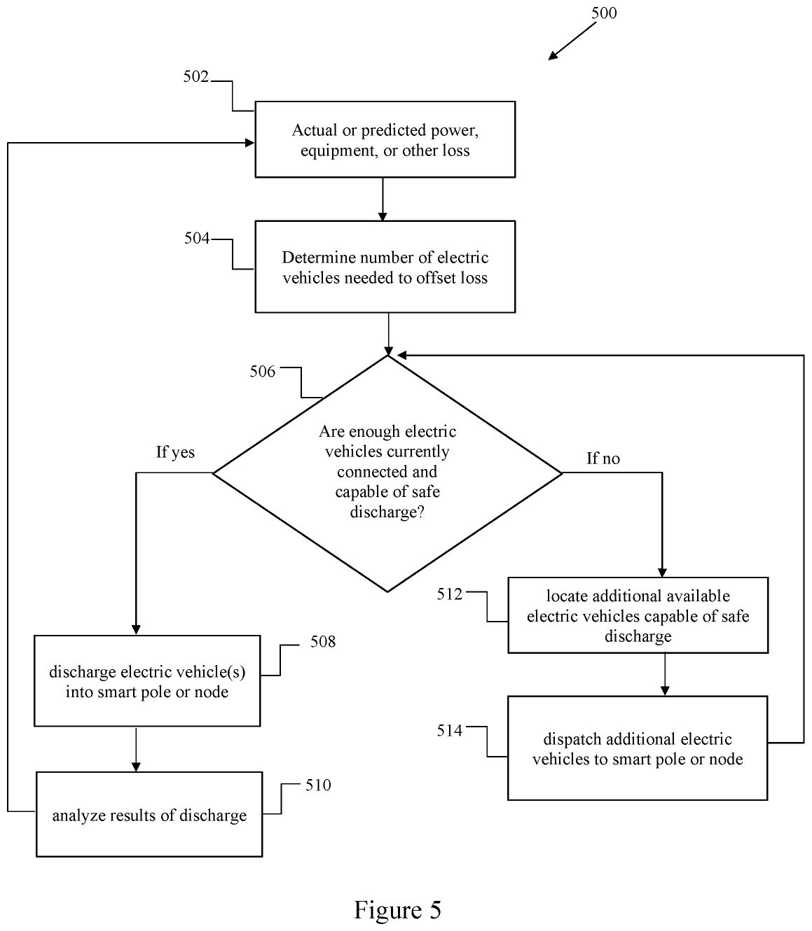

FIG. 5 depicts a method 500 for using the resilient smart pole system 100 or resilient infrastructure 200, 300, 400 to provide mobile back-up power via bidirectional charging according to an embodiment of the present invention. At step 502 there may be a signal or other suitable message, notification, or indicator of actual or predicted power, equipment or other loss. At step 504, a number of electric vehicles needed to offset the loss may be determined. At step 506, a number of electric vehicles that are available and capable of safe discharge may then be determined. Whether there are enough electric vehicles currently connected to a smart pole or to a node(s) of a circuit containing one or more smart poles may be determined at step 508. If yes, the method proceeds to step 510 where the electric vehicle(s) are discharged into the smart pole(s) and/or node (s). After the discharge is completed, the results of the discharge may be analyzed at step 512 to improve upon discharge operations for future power, equipment or other losses.

If the determination at step 508 is no, then the method 500 proceeds to step 514 to locate additional available electric vehicles that are capable of safe discharge (e.g., won't be detrimental to battery health or won't void battery warranty). At step 516, those additionally located electric vehicles may be dispatched to the smart pole or node of a circuit containing one or more smart poles. After dispatching, the method returns to step 508 and repeats steps 514 and 516 until the determination at step 508 is that yes, there are enough electric vehicles currently connected. At this point, the method proceeds with steps 510 and 512 as described above. In one example, the steps are performed by centralized computer 118 (as described below) but may be performed by any suitable software in communication with the smart pole 108 or nodes 108a-e of resilient infrastructure 200 (including the examples above).

Regarding step 502, there may be a signal indicating a power loss, power supply failure, equipment failure, or other loss at a smart pole 108 or a node 108a-e of the resilient infrastructure 200, 300, 400. In another example, power loss, power failure, equipment failure, or other loss may be predicted/anticipated for a smart pole 108 or a node 108a-e of the resilient infrastructure 200, 300, 400. A centralized computer 118 may receive and analyze inputs of various data elements, such as, weather data (e.g., current forecast information and/or historical weather data), information about components of the smart pole 108 or the resilient infrastructure (e.g., monitoring length of time component has been in use), to predict or anticipate power loss, power failure, equipment failure, or other loss at the smart pole 108 or a node 108a-e of the resilient infrastructure 200, 300, 400. As described above, the signals may be sent by centralized computer 118 or other software, the utility company, telecommunications provider, or other source monitoring the smart pole 108 or nodes 108a-e of the resilient infrastructure 200, 300, 400. Also as described above, the signals may be received by an operator or manager of a fleet electric vehicles or by operations management component 116 (or other software 122 running on centralized computer 118 with processor 120) that is part of an electric vehicle 102 and/or bidirectional charger 106 (i.e., signal recipient or recipient of signal). The signals may also be created by software that is stored in the cloud or on another suitable external server, such as the centralized computer 118.

Regarding step 504, determining the number of electric vehicles needed to discharge the amount needed to offset the loss may involve analyzing one or more factors to determine the number, including, but not limited to, how many smart poles 108 are affected, expected length of duration of loss, amount of time onsite secondary or stationary back-up power source can last, average power consumption of the smart pole 108 or node 108a-e, etc.

At step 506, the centralized computer 118 may determine whether there are enough electric vehicles 102 currently connected to the smart pole 108 or to a node 108a-e of the resilient infrastructure 200. If at least one electric vehicle 102 is connected, the centralized computer 118 may then analyze data to determine whether the connected electric vehicle(s) 102 are capable of discharging into the smart pole 108 or into the node 108a-e of the resilient infrastructure 200, 300, 400. The data may include state of charge of the electric vehicle 102, time since last discharge event, vehicle battery size (e.g., 60 kWh vs. 30 kWh), battery voltage, maximum charge and discharge current levels, vehicle status, average state of charge experienced throughout the battery's life, anticipated near-term energy requirements for the vehicle, temperature and humidity profile for location of electric vehicles and chargers, minimum battery state of charge, rate of charge/discharge relative to maximum energy capacity (“c-rate”), depth of discharge (“DoD”) that battery is cycled to (e.g., 50% DoD means the battery is charged or drained to half its capacity), total energy throughput cycled in and out of the battery, and the temperature at which cycling occurs or any other suitable vehicle data. Examples of when it may be detrimental to battery health to discharge an electric vehicle (i.e., electric vehicle may not be capable of discharging) are also discussed in U.S. patent application Ser. No. 16/802,808, published as U.S. Pat. No. 11,135,936, the disclosure of which is hereby incorporated by reference as if fully set forth herein.

For example, at step 504, the centralized computer 118 may determine that two electric vehicles are required to be connected in order to offset the actual or predicted loss. At step 506, the centralized computer 118 may then determine that two electric vehicles are currently connected at the site experiencing or predicted to experience a loss. The centralized computer 118 then analyzes factors, such as those described above, to determine whether the two electric vehicles are capable of being discharged to offset the loss. In this example, the centralized computer 118 may determine that due to a recent discharging event (or other factor), one of the two connected electric vehicles is only able to discharge at a rate that is half of the maximum energy capacity. Thus, the centralized computer 118 would use this information to determine that one of the connected electric vehicles is not capable of safe discharge, and that while the determined number are connected, due to limitation of the discharge rate (or other factor), the two connected vehicles are not enough to offset the loss. In this example, the method would proceed to step 512, as depicted in FIG. 5.

If the centralized computer 118 determines that there are enough electric vehicles currently connected and capable of safe discharge, then at step 508 the electric vehicle(s) 102 begins discharging power into the smart pole 108 or node 108a-e of the resilient infrastructure 200, 300, 400. After the power loss, power failure, equipment failure, or other loss is restored or otherwise resolved, such that the electric vehicle 102 no longer needs to discharge to supply back-up power, the centralized computer 118 may analyze the results of the discharge at step 510. Analyzing the results of the discharge may include identifying the amount (percentage) of charge used, how long the electric vehicle 102 supplied power to the smart pole 108 or node 108a-e of the resilient infrastructure 200, length of outage, percentage of functionality powered for smart pole 108 or node 108a-e by the electric vehicle 102, or other factors (e.g., battery temperature or ambient air temperature) that may have affected the discharging operation. The analysis of the results may be used to improve upon future deployments of electric vehicles for providing back-up power such that the centralized computer 118 becomes “smarter” and more accurate over time. This could be achieved, for example, using known artificial intelligence self-learning techniques.

If at step 506, the centralized computer 118 determines that an electric vehicle is not connected to smart pole 108 or a node 108a-e of the resilient infrastructure 200, 300, 400, the centralized computer 118 may proceed with step 512. At step 512, the centralized computer 118 may locate additional available electric vehicle(s) 102 that are capable of safe discharge, according to the number determined at step 504. At step 514, the centralized computer 118 sends a command or instructions to dispatch the located additional electric vehicle(s) 102 to the smart pole 108 or node 108a-e of the resilient infrastructure 200, 300, 400. Once connected, the method 500 would proceed with step 506. This could be repeated as needed until a sufficient number of electric vehicles are connected to the smart pole(s) 108 or node 108a-e of the resilient infrastructure 200, 300, 400. After the loss is resolved/power restored, the electric vehicle 102 may be disconnected and sent on to another use or may remaining connected and charging at the smart pole 108 or node 108a-e.

Step 512 may be accomplished through any suitable means. In one example, an operator (e.g., telecommunication provider, 5G or other network operator, power utility company, etc.) may save data from electric vehicles that have been plugged in to a smart pole 108 or node 108a-e. This data may be used to prioritize which additional vehicles are dispatched because the operator would know the battery health of the electric vehicle, last throughput event, etc. In one example, the operator could own or lease or otherwise have access to a dedicated fleet of electric vehicles to be used in the event of power outages. The operator could have an established relationship with a fleet of vehicles (e.g., for a municipality, waste management company, school buses, rideshare groups, or other fleet) or even with personal electric vehicle owners. The operator could contact the fleet of vehicles or review an inventory of vehicles accessible to the operator to determine availability and capability of safe discharge, including by analyzing the above described data or factors. When an electric vehicle connects to a smart pole, the operator may have the electric vehicle owner/user register, select, or otherwise indicate whether they are willing to use their vehicle for future V2X applications, including supplying back-up power in the event of a power outage to the smart pole. The operator may collect other information from the electric vehicle owner/user, including contact information (e.g., telephone number). This information could be saved and stored on the centralized computer 118, in the cloud, or any other suitable database. In this example, the operator could send a message to all electric vehicles that have previously plugged in to the smart poles and indicated they are willing to use their vehicle for V2X applications. The message could be sent to the operations management component 116 of the electric vehicle 102, in one example, or via text message or phone call to the electric vehicle owner/user.

In another example, vehicle owners, operators, or managers may be provided with incentives to keep their vehicle 102 charging at the smart pole 108 or node 108a-e in return for agreeing to allow their vehicle 102 to be discharged into the smart pole 108 or node 108a-e in the event of a future loss of power, such as an emergency outage. The incentives may include, but are not limited to, free charging during the duration of the predicted weather event, a credit or reduction on utility bill, or a credit or reduction on bill from telecommunications provider. In another example, the telecommunications provider could own or lease or otherwise have access to a dedicated fleet of electric vehicles to be used in the event of emergency outages. The telecommunications provider could have an established relationship with a fleet of vehicles (e.g., for a municipality, waste management company, school buses, rideshare groups, or other fleet) or even with personal electric vehicle owners who agree to connect their electric vehicles at smart poles experiencing an outage due to scheduled maintenance, a storm, disaster, other emergency, or other causes of power outage.

In an example of method 500, centralized computer 118 could receive weather forecast information that in two days, a town is expected to receive 8 inches of snow with 30 mile per hour winds (step 502). The centralized computer 118 may access historical weather data to determine whether similar conditions have resulted in power outages in the past (step 502). From the historical weather data, the centralized computer 118 may determine that similar amounts of snow and wind resulted in a six-hour power outage in previous years (step 502). The centralized computer 118 may determine the number of smart poles 108 operating in the town (e.g., from a database or records of the town, utility provider, telecommunications operator, etc.) and calculate the average amount of power used by those smart poles 108 in a six hour period (e.g., taking into account if the power outage occurs during the day when it is likely more power is expected to be used or night when it is likely that less power would be expected to be used and accessing logs from utility company regarding power usage by the smart poles 108) (step 504). Once the centralized computer 118 estimates an amount of expected power usage for the affected smart poles 108, the centralized computer 118 may determine the number of fully charged electric vehicles 102 that would be required to meet those power needs for the duration of the expected outage (step 504). The centralized computer 118 may build in a suitable buffer, as required by the computer 118, town, telecommunications provider, etc. After determining the number of fully charged electric vehicles 102 required, the centralized computer 118 may send deployment or dispatch instructions or commands to the electric vehicles 102 and ensure those vehicles 102 are connected and fully charged at the smart poles 108 at the beginning of the weather event (see above discussion of deployment and dispatch). Once the electric vehicles 102 are connected, in the event of a power loss or failure, the centralized computer 118 may proceed as described above.

In an alternative embodiment, the determined number of electric vehicles may be driven away and parked at a safe place (i.e., outside the forecasted impact of the anticipated storm or weather event) where the vehicles remain until the storm has passed, leaving a power outage behind. At that point, the electric vehicles 102 may be driven to the smart poles 108 experiencing the power loss or failure. Once the electric vehicles 102 are connected, the centralized computer 118 or software on the electric vehicles 102 may proceed as described above.

In the event of a disaster scenario, as described above, there may not be any communication system available. In this example, a fleet of electric vehicles (or individual personal electric vehicles) could have a prior agreement with the municipality, telecommunications provider, or other operator of the smart poles 108 to connect their electric vehicles to a smart pole 108 or node 108a-e when there is an emergency outage. When the communication system is operational again, the electric vehicles may be coordinated, for example as described above.

In an example where communications are not available due to a disaster or other widespread outage, the resilient infrastructure for providing back-up power via bidirectional charging described herein may need to operate without a centralized computer. A processor or other suitable computing components located at the smart pole may disconnect the smart pole and/or circuit of smart poles from the electric grid or other power source 114 (e.g., powered for a short time by a secondary source of power on site). The computing components may also be able to detect when a viable (i.e., able to discharge into the smart pole) has been plugged-in or otherwise connected to the smart pole. An operations management component 116 or other software on the electric vehicle could then manage the charging operation until communications are restored. The electric vehicle may provide a “black-start” solution to re-power the smart pole and restore operation to the smart pole circuit in the event of an outage of the grid or other power source 114.

It should be understood that the resilient infrastructure for providing back-up power via bidirectional charging as described herein is for the purpose of describing a particular implementation only and is not intended to be limiting of the disclosure. The resilient infrastructure for providing back-up power via bidirectional charging could implemented with power components (smart or otherwise) for other existing networks (e.g., 5G, 4G, or LTE), future generations of networking technology (e.g., 6G), or other forms of applied bandwidth technologies.

It should be understood that the terminology used herein is for the purpose of describing particular aspects only and is not intended to be limiting of the disclosure. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A system for providing a resilient bidirectional charging infrastructure comprising:
a plurality of smart poles connected in a circuit, wherein the plurality of smart poles is configured to provide at least part of a powered network, and wherein at least one of the plurality of smart poles comprises an interface for receiving electricity from an electric vehicle; and
a processor configured to cause the at least one of the plurality of smart poles to receive electricity from the electric vehicle based on an actual or predicted loss of electricity within the circuit.

2. The system of claim 1, wherein the processor is further configured to:
in response to an identification of an actual or predicted loss of electricity within the circuit, determine whether the electric vehicle is electrically connected to the at least one of the plurality of smart poles; and
in response to determining that the electric vehicle is not electrically connected to the at least one of the plurality of smart poles, initiate a message requesting that the electric vehicle be electrically connected to the at least one of the plurality of smart poles.

3. The system of claim 2, wherein the processor is further configured to:
analyze whether to deploy at least one electric vehicle to the smart pole;
initiate a dispatch signal requesting to dispatch the at least one electric vehicle to the smart pole;
initiate a discharge signal requesting to discharge the at least one electric vehicle into the smart pole via the bidirectional charger; and
analyze the results of discharging the first electric vehicle or the at least one electric vehicle into the smart pole via the bidirectional charger to improve ability to respond to future losses of power.

4. The system of claim 2, wherein the processor is further configured to:
analyze weather forecast data for one or more geographic areas at which the plurality of smart poles are located; and
identify an anticipated weather event from the weather forecast data.

5. The system of claim 4, wherein the processor is further configured to:
analyze historic weather data to identify comparable historic weather events to the anticipated weather event; and
analyze historic data to identify loss of power statistics for the comparable historic weather events.

6. The system of claim 5, wherein the processor is further configured to:
estimate a duration of a predicted loss of power to the smart pole from the anticipated weather event from the loss of power statistics; and
calculate an amount of power that would be used by the smart pole during the duration of the predicted loss of power.

7. The system of claim 6, wherein the processor is further configured to:
determine a number of electric vehicles required to provide the calculated amount of power for the estimated duration of the predicted loss of power; and
initiate a message requesting that the determined number of electric vehicles be dispatched to the one or more geographic areas at which the plurality of smart poles are located before the anticipated weather event begins.

8. The system of claim 7, wherein the processor is further configured to:
in response to an identification of an actual loss of electricity within the circuit, initiate a message requesting that the dispatched electric vehicles be discharged into at least one of the plurality of smart poles.

9. The system of claim 8, wherein the processor is further configured to:
analyze the results of discharging the dispatched electric vehicles into least one of the plurality of smart poles via a bidirectional charger to improve ability to predict future losses of power.

10. The system of claim 2, wherein electrically connected comprises directly plugged in to the smart pole or connected to a node of the circuit.

11. A method for providing a resilient bidirectional charging infrastructure comprising:
in response to an identification of an actual or predicted loss of electricity within a plurality of smart poles connected in a circuit, determining whether an electric vehicle is electrically connected to at least one of the plurality of smart poles, wherein the plurality of smart poles is configured to provide at least part of a powered network, and wherein at least one of the plurality of smart poles comprises an interface for receiving electricity from the electric vehicle; and
in response to determining that the electric vehicle is not electrically connected to the at least one of the plurality of smart poles, initiating a message requesting that the electric vehicle be electrically connected to the at least one of the plurality of smart poles.

12. The method of claim 11, further comprising:
analyzing whether to deploy at least one electric vehicle to the smart pole;
initiating a dispatch signal requesting to dispatch the at least one electric vehicle to the smart pole;
initiating a discharge signal requesting to discharge the at least one electric vehicle into the smart pole via the bidirectional charger; and
analyzing the results of discharging the first electric vehicle or the at least one electric vehicle into the smart pole via the bidirectional charger to improve ability to respond to future losses of power.

13. The method of claim 12, further comprising:
analyzing weather forecast data for one or more geographic areas at which the plurality of smart poles are located; and
identifying an anticipated weather event from the weather forecast data.

14. The method of claim 13, further comprising:
analyzing historic weather data to identify comparable historic weather events to the anticipated weather event; and
analyzing historic data to identify loss of power statistics for the comparable historic weather events.

15. The method of claim 14, further comprising:
estimating a duration of a predicted loss of power to the smart pole from the anticipated weather event from the loss of power statistics; and
calculating an amount of power that would be used by the smart pole during the duration of the predicted loss of power.

16. The method of claim 15, further comprising:
determining a number of electric vehicles required to provide the calculated amount of power for the estimated duration of the predicted loss of power; and
initiating a message requesting that the determined number of electric vehicles be dispatched to the one or more geographic areas at which the plurality of smart poles are located before the anticipated weather event begins.

17. The method of claim 16, further comprising:
in response to an identification of an actual loss of electricity within the circuit, initiating a message requesting that the dispatched electric vehicles be discharged into at least one of the plurality of smart poles.

18. The method of claim 17, further comprising:
analyzing the results of discharging the dispatched electric vehicles into least one of the plurality of smart poles via a bidirectional charger to improve ability to predict future losses of power.

19. The method of claim 18, wherein electrically connected comprises directly plugged in to the smart pole or connected to a node of the circuit.

20. A non-transitory computer-readable storage medium having instructions stored thereon that are executable by a computing system to:
in response to an identification of an actual or predicted loss of electricity within a plurality of smart poles connected in a circuit, determine whether an electric vehicle is electrically connected to at least one of the plurality of smart poles, wherein the plurality of smart poles is configured to provide at least part of a powered network, and wherein at least one of the plurality of smart poles comprises an interface for receiving electricity from the electric vehicle; and
in response to determining that the electric vehicle is not electrically connected to the at least one of the plurality of smart poles, initiate a message requesting that the electric vehicle be electrically connected to the at least one of the plurality of smart poles.
